(19) United States
(12) Patent Application Publication
(10) Pub. No.: US 2010/0145935 A1
(43) Pub. Date: Jun. 10, 2010

(54) DATA NETWORK SERVICE BASED ON PROFILING IP-ADDRESSES

(75) Inventor: Ate Sander Van Steenbergen, The Hague (NL)

Correspondence Address: MICHAELSON & ASSOCIATES, P.O. BOX 8489, RED BANK, NJ, 07701-8489, US

(73) Assignee: KONINKLIJKE KPN N.V., The Hague (NL)

(21) Appl. No.: 12/448,183

(22) PCT Filed: Dec. 19, 2007
(86) PCT No.: PCT/EP2007/011148

§ 371 Date: Feb. 1, 2010

Related U.S. Application Data
(60) Provisional application No. 60/875,638, filed on Dec. 19, 2006.

(51) Int. Cl. G06F 17/30

(52) U.S. Cl. 707/723; 707/748; 707/769; 707/803; 707/E17.044; 707/E17.014

(57) ABSTRACT

At a network access point, the requests are monitored that clients submit to a plurality of server addresses. A database is formed for mapping of the client population onto the server addresses. This enables determining which of the server addresses are more popular than others with a specific segment of the client population. Segmenting the client population is based on commonalities in attributes extracted from the requests. This mapping enables other data network services such as web portals and search engines to target specific segments of the client population.

### FIELD OF THE INVENTION

The invention relates to, among other things, a method of providing a service on a data network, and to a method of operating a server on a data network.

### BACKGROUND ART

Nowadays many users around the world are accessing the Internet frequently for many different purposes, e.g., finding information on all kind of topics, sharing information and experiences with other people, downloading music or movies, etc. Since there is so much information available on the Internet, both provided by companies but also by individual users, al kind of tools are provided to facilitate a user finding the information he actually needs or likes to find, e.g., search engines, and web portals. But these tools are still targeted to a large audience and not dedicated to an individual user.

By analyzing the web browsing activities of a user service providers and content providers can gain insight in the interests of individual users and better target search results and web portals.

U.S. Pat. No. 7,020,082, herein incorporated by reference, discloses a network usage monitoring module for monitoring network usage at a network access point, i.e., network traffic aggregation point, typically at a gateway device or a similar network interface device. As such, the network usage monitoring module can monitor the usage of a number of network users who are attempting to access various network services provided via the gateway device. Thus, the usage information collected by the usage monitoring module is considerably more robust than that offered by conventional monitoring techniques. As such, the information is considerably more valuable to network service providers, network users, network beneficiaries and the like. In addition, the usage monitoring method and apparatus offers a number of particular features to improve the monitoring process as well as the value of the usage information that is collected.

The drawbacks of this module are that usage is monitored on a per user basis, that the content of the websites visited by the user is not taken into account, and that the usage is stored based on a subscriber identity that is only known within the module.

U.S. Pat. No. 6,256,633, herein incorporated by reference, discloses a method of enabling a user to navigate through an electronic data base in a personalized manner. A context is created based on a profile of the user, the profile being at least partly formed in advance. Candidate data is selected from the data base under control of the context and the user is enabled to interact with the candidates. The profile is based on topical information supplied by the user in advance and a history of previous accesses from the user to the data base. A drawback of this personal navigation is that the profile is formed per individual user, so that the user is to be very specific about the topical information supplied in advance or is to have a long history of accesses so as to be able to extract his/her profile. Another drawback is that the user more or less relinquishes his/her privacy.

### SUMMARY OF THE INVENTION

The invention provides an alternative to the known approaches by taking into account the collective behavior, or group behavior, of multiple users in a client-server architecture of a data network, with respect to a plurality of servers so as to profile the servers against the background of the interacting clients.

The inventor proposes a method of providing a service on a data network. The data network comprises a plurality of clients and a further plurality of servers. Each specific one of the further plurality of servers has at least a specific one of multiple server network addresses. The method comprises following steps. At a network access point on the data network, the requests are monitored as submitted by the plurality of clients to the multiple server addresses. A database is created with data representative of the monitored requests. Information is extracted from the database indicative of a group behavior of at least one particular group of clients of the plurality of clients with respect to accessing of the multiple server addresses. The extracting comprises determining the particular group based on a commonality in a particular sub-set of the requests. The commonality is determined by the sub-set having at least one attribute in common. For example, the particular group is determined on the basis of their clients having the same hardware configuration or software configuration as can be identified by user-agent strings submitted in the requests. This example is discussed in more detail below. Other attributes that can be considered for this purpose are, for example, a geographic aspect (e.g., geographic region) of client network addresses indicated in the monitored requests submitted by the plurality of clients; a temporal aspect (e.g., time of the day at the client) of the monitored requests; data representative of respective semantic content of respective responses (e.g., characterizing keywords in a text of a web page) by the further plurality of servers to the plurality of clients upon the requests. The extracting further comprises identifying particular ones of the server addresses in the particular sub-set of the requests. The particular server addresses are ranked according to a measure of popularity, such as the number of times a particular address occurs in the requests monitored over a specific time interval (i.e., the frequency of the address). The frequency of a particular address can be given a weighing factor to account for other criterions such as semantic content or a degree of popularity with other groups of clients, etc. In the ranking thus created, whether or not using weighing factors, one or more higher ranking ones of the particular server addresses are identified, e.g., the two server addresses with the highest ranking in this particular sub-set. These higher ranking server addresses are then stored as associated with the particular client group. Note that this is an ongoing dynamic process wherein the rankings and the server addresses ranked can change over time.

Accordingly, the invention enables to monitor the requests sent from a population of clients to a collection of servers. The requests themselves enable to identify a behavioral pattern of the clients with respect to the further plurality of servers. This in turn enables to profile a representation of the plurality of servers with respect to the browsing behavior of the population of accessing clients, or otherwise create a mapping of the plurality of servers on groups of clients. For example, a behavioral pattern of a certain group of clients, identified by a first attribute, is found to involve significantly more accesses to a particular group of server addresses, identified by another attribute, than do other clients. The invention thus enables to create a mapping of the server network addresses onto the clients, the latter grouped according to one or more attributes so as to be able to detect pronounced relationships between certain server addresses and groups of clients.

A behavioral pattern of the clients indicates, for example: which ones among the servers (or: server addresses) are more popular than other ones of the servers (or: server addresses); or which server addresses are more popular than other server addresses with clients having a particular configuration (e.g., a mobile client, a stationary client, brand of client, etc.), or which ones of the server addresses are more popular than other server addresses with clients of a certain profile in terms of a combination of attributes. Within this context, the term “combination” is also considered to include any combination of Boolean operators operating on the presence or absence of the attributes in the requests considered so as to implement a Boolean filter. For example, one may be interested in that particular group of clients that reside within a certain geographical region (which can in general be inferred from their network addresses) and that do not access the servers on certain days, or that are mobile clients (as can be inferred from the user-agent strings). For completeness, a server may have two or more server addresses, each respective one thereof being the address of a respective page, or a respective service, etc., provided at that server.

In an embodiment, the particular group is identical to the monitored population as a whole, and the commonality is then equal to the fact that any monitored client is a member of the monitored population. In this embodiment, the invention thus enables to identify, e.g., the server network addresses most popular with the monitored population as a whole. In other embodiments, the particular group of clients is smaller than the monitored population as a whole and is selected from this population according to, e.g., the Boolean filter discussed above.

The creation of above mapping of a client population, monitored at a network access point, onto server addresses occurring in the requests from the clients is based on a popularity measure upon filtering under control of selected client attributes. This mapping enables other data network services to target specific segments of the client population.

Accordingly, the inventor therefore proposes a method of providing on a data network a web portal service that is targeted to a segment of a population of a plurality of clients. The plurality of clients uses a network access point for submitting requests to a further plurality of servers on the data network. Each respective one of the further plurality of servers has at least one respective one of multiple server network addresses. The method comprises consulting a database storing the server network addresses occurring in the requests, and storing identifications of the plurality of clients having submitted these requests. The identifications comprise one or more attributes per client. The method further comprises determining particular ones of the plurality clients belonging to the targeted segment having one or more particular ones of the attributes in common. The method comprises further determining at least one particular one of the server network addresses occurring more often than at least one other one of the server network addresses in particular ones of the requests submitted by the particular clients. The method then comprises including in the portal a hyperlink to a server site on the data network identified by the particular server network address selected.

Accordingly, specific web portals can be created for clients having a certain profile as given by their attributes, e.g., a web portal specifically for users of mobile clients. The web portal has hyperlinks to precisely those web sites that are popular with this segment of the client population. A further specialization can be made by providing a web portal for mobile client devices having a specific hardware configuration or software configuration (e.g., screen resolution, version or brand, onboard processing power, onboard memory capabilities, etc.). Information about the configurations can be found in the user-agent strings submitted by the clients.

In an embodiment, the web portal can change the hyperlinks dynamically, e.g., once or twice per day or before and after each weekend, so as to take into account a temporal browsing behavior of a particular segment of the client population showing a similar pattern in time with respect to attention shifts, as can be determined by consulting the database.

Another embodiment of the invention relates to a method of providing on a data network a search engine service to a population of a plurality of clients. The plurality of clients uses a network access point for submitting requests to a further plurality of servers on the data network. As the clients use this network access points, their browsing behavior can be monitored and profiled. Each respective one of the further plurality of servers has at least one respective one of multiple server network addresses. The method comprises receiving from a specific one of the plurality of clients a specific request for searching the further plurality of servers for a specific information item. The search engine provider then makes an inventory of specific ones of the further plurality of server addresses providing the specific information item. The provider consults a database storing the server network addresses occurring in the monitored requests, and storing identifications of the population, the identifications comprising one or more attributes as specified above. A specific one of the attributes of the specific client is determined. Then a ranking of the specific server network addresses is determined according to a measure of popularity with a segment of the population of a plurality of clients, the segment being identified in the database by the specific attribute. Then the service provider supplies to the specific client search results ranked according to the ranking determined. Accordingly, the search results created upon a request from a specific client are ranked according to a measure of popularity with the population segment whereto this specific client belongs on the basis of the attributes. Alternatively, the service provider only searches the sites of those server network addresses that occur in the monitored requests submitted by the population segment to which the specific client belongs on the basis of the attributes.

The invention is also applicable to mobile Internet browsing. The expression “Mobile Web” has been coined and refers to the world-wide web as accessed from mobile devices such as cell phones, network-enabled personal digital assistants (PDAs), and mobile computers such as small laptops. A mobile browser is a web browser designed for use on such a mobile device. Users can browse the Internet from their mobile devices via, e.g., UMTS (Universal Mobile Telecommunications System) networks, GPRS (General Packet Radio Service) 3G networks, etc. The mobile telephones connect to the Internet via a gateway, functionally similar to scenarios of the clients accessing the Internet via a router as discussed above. Accordingly, where reference is made to a client throughout this text, the term “client” is also meant to cover a mobile network-enabled device where appropriate in the context of this description.

### BRIEF DESCRIPTION OF THE DRAWINGS

The invention is explained in further detail, by way of example and with reference to the accompanying drawing, wherein:

FIGS. 1 and 2 are diagrams of systems in the invention.

Throughout the Figures, similar or corresponding features are indicated by same reference numerals.

### DETAILED EMBODIMENTS

At a network access point, the requests are monitored that clients submit to a plurality of server addresses. A database is formed for mapping of the client population onto the server addresses. This enables determining which of the server addresses are more popular than others with a specific segment of the client population. Segmenting the client population is based on commonalities in attributes extracted from the requests. This mapping enables other data network services such as web portals and search engines to target specific segments of the client population.

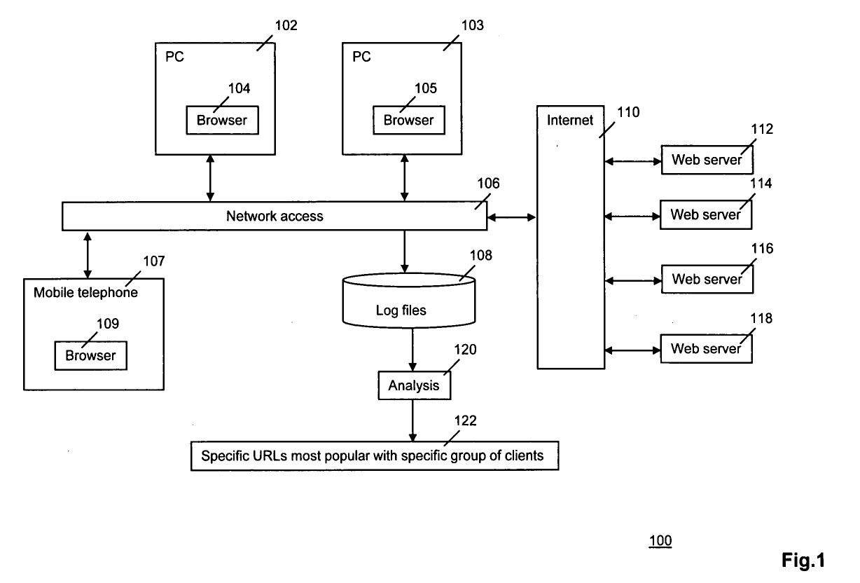

FIG. 1 is a diagram of a system 100 in the invention. System 100 comprises a client 102, e.g., a PC 102 with a browser 104, a client 103, e.g., a PC 103 with a browser 105, a client 107, e.g., a mobile telephone with a browser 109, access network 106, e.g., a router network or a gateway, a memory 108 for storing log files, a data network 110 such as the Internet, and a plurality of web servers 112, 114, 116 and 118. FIG. 1 illustrates only clients 102, 103, and 107, and does not show more clients in order to not obscure the drawing. Access network 106 is operative to log all HTTP request from the clients, e.g., client 102, client 103 and client 107, in log-files of memory 108. The log files contain, e.g., the IP address from which the request originated and the destination URL of the requested website residing at one of servers 112-118, from now on referred to as “URL”. The set of URLs requested by the same IP address is referred to as a “click stream”. In this text it is assumed that there is a one-to-one relationship between an IP address and the user at the client associated with this IP address. Accordingly, in this example, the user of PC 102 is associated with a first IP address and the user of PC 103 is associated with a second IP address different from the first IP address. Instead of, or in addition to logging the IP addresses of the requesting clients, another identifier or attribute of the relevant client can be stored, e.g., a user-agent string. A browser of a client, e.g., browser 109 of mobile client 107, adds to the request information, a user-agent string with information about client 107. The user-agent string is indicative of, e.g., brand of the device, type of the device, type of the brower of the device, versions thereof, etc.).

System 100 comprises a module 120 for analyzing the click streams associated with different clients in order to group the clients based on their click streams having one or more attributes in common, e.g., the same client configuration as indicated in the user-agent string or the same geographic region or time zone as can be inferred from their IP addresses, etc. Module 120 identifies the URLs of servers 112-118 that typically occur in request submitted by this particular group of clients or the URLs that are the most popular in terms of a higher frequency of occurrence in this group's requests than other URLs. Once such a relationship is found, the URLs are stored in a memory 122 as associated with this particular client group. In an embodiment, module 120 identifies several groups of clients, each with their own set of most popular or most typical URLs, and stores in memory 122 these sets of URLs as associated with their respective client groups.

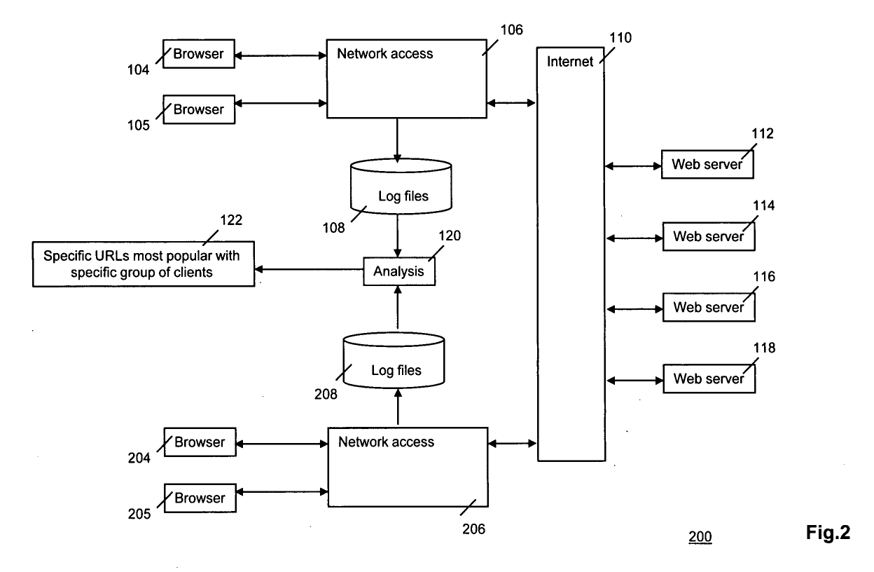

FIG. 2 is a diagram of another system 200 of the invention. System 200 includes system 100 as discussed under FIG. 1, plus browsers 204 and 205 residing at other clients (not shown), network access (e.g., a router network or a gateway) 206 and a memory 208 for storing the log files of the clients associated with browsers 204 and 205. Now, relationships between client groups and associated most popular URLs are formed based on the HTTP requests via network access 106 and network access 206. System 200 can be expanded by including more network access systems (not shown) and by taking their log-files into account as well.

Now consider the following scenario, wherein all URL requests submitted by the population as a whole, can be ranked according to frequency. That is, a first URL has been requested a first number of times, and a second URL has been requested a second number of times, all within a certain time period or since a start time. This then enables a ranking of URLs, based on their frequencies in the requests as monitored for the profiling purposes as discussed above. Note that in this scenario the ranking of search results in the response of a search engine can be transformed to another ranking reflecting the interests of the user population monitored. That is, an ordered list of search results can be permutated so as to have the URLs ranked according to popularity as measured at the network access point. Also, a portal can be created for the monitored population with direct access to the Web sites, most popular with the monitored population, selected on the basis of the frequencies. Alternatively, or in addition, the browser of the client adds to the request information, e.g., a user-agent string, about the device. The user-agent string is indicative of e.g., brand of the device, type of the device, type of the browser of the device, versions thereof, etc.). This then enables the service provider, e.g., a provider of a search engine for mobile users, to rank or otherwise categorize or select the URLs according to the brands and types of the mobile devices that have issued earlier requests and have indicated which URLs are more popular or more suitable with this brand or type of a particular mobile device. This can be shown to the user without any additional steps to be performed by the user, as the browser of the device also adds the user-agent-string to the request submitted to the web-site or search-engine. Hence, the search-engine or web-site can use this as a criterion to determine the response, or customize the response, for that specific request of that specific device. In turn, the web pages associated with the URLs most frequently accessed by specific mobile devices can be made accessible in a portal especially developed for these specific mobile devices based on their high ranking in the monitored requests issued by these devices. This development can be carried out on an ongoing basis, so that the sites, which are the most popular with a specific type or brand of mobile device, are always readily accessible through the portal.

For completeness, the expression “user agent” is a common expression in the technical field and refers to a client application used with a particular network protocol. Within the context of the Internet, the user agent is the application (e.g., a browser or a crawler) that accesses the World Wide Web. Within the context of the Session Initiation Protocol (SIP) the expression “user agent” typically refers to the user's telephone. When a user visits a web site on the Internet, a text string is sent in order to identify the user agent with respect to the server. This forms part of the HTTP request, prefixed with the string “User-agent” or “User-Agent”. This typically includes information such as the application name, version, host operating system, hardware and language.

These scenarios can even be taken further if one takes into account, e.g., the extension of the URL, without having to analyze the content information itself of the associated site. The extensions indicate whether the content information is a movie file, an audio file, a ring-tone, plain HTML, etc. Accordingly, the files (e.g., ring-tones) that are downloaded most often or the sites providing such files (e.g., a site providing access to a ring-tone database) and visited most often, can be ranked at the top of the list when responding to a request issued by a specific device.

In another scenario, the semantic content of the web pages is analyzed, the pages being identified by the URLs in the monitored requests. Now, a division can be made according to topic, and search results of a query about this topic can be ranked according to their frequencies derived from the requests from the monitored population.

Note that search engine providers do not have the means to monitor web accesses to other servers. Accordingly, they cannot tailor the search results to the browsing behavior of the monitored population. In particular, a server has in general information about all requests only received at its address. A search engine can document all search requests submitted to it. However, only a network access point, e.g., a router or gateway, can monitor all requests submitted by the population using the access point, independent of the destination of the request (e.g., a specific server or search engine). Accordingly, the network access point has information about the different sites to which requests are sent as well as about the population served via this access point. For a large enough population, the requests can be profiled as discussed above, the profiles then conveying significant information about the population. This information can be made available to, e.g., providers of search engine web sites and to web portal providers. This information enables the provider of a search engine web site to filter or otherwise customize the search results taking into account the popularity profiles of the URLs associated with the specific client as discussed above. Similarly, consider a web portal provider who intends to target a specific segment of the population, e.g., users of mobile clients, or users of a specific type of mobile clients. The URLs most popular with these segments can be identified in the monitored requests as submitted by the population as whole, as discussed above, based on the user-agent strings. Accordingly, the information in the database, built by means of monitoring the requests, provides valuable information to the web portal provider in the sense that the web portal is attractive to the targeted segment if the portal comprises direct hyperlinks to the sites most popular with this segment.

Devices with mobile browsers typically have limited capabilities with regard to screen real estate, user interactivity, onboard memory, etc. For users of such devices, it is important to be able to readily find those network sites that are suitable for these devices. The invention therefore enables these users to readily find these sites, because their URLs are automatically being ranked at the top of the list of URLs of the requests submitted from mobile devices, precisely as a result of their being submitted most often from mobile devices of the same category or profile.

Some devices are more popular with certain segments of the population than with other segments, e.g., as a result of marketing and advertising campaigns targeting certain segments. For example, the Motorola Pebble and LG Chocolate are mobile phones particularly appreciated by women between 30 and 40 years young, whereas the Sony-Ericsson mobile phones are largely very popular with teenagers. Accordingly, these devices already segment the population. As a result, a correlation can be assumed to exist between a user of such a particular device on the one hand and his/her interests on the other. Now, by ranking the URLs according to both population segment and device capabilities, chances are increased that the URLs higher in the ranking are more interesting to these particular users than other URLs (lower in the ranking or not even ranked). It has been assumed here that as a result of marketing campaigns and segmenting by the telecom operators, target groups of these segments share a common interest in the information content of web sites as a result of their shared preference for a specific device type. Accordingly, the population can be segmented as a result of marketing campaigns. People belonging to a specific population segment have an attribute in common, such as browsing behavior, interest, age. These different segments form target groups for different mobile devices. As a consequence, a specific population segment has one or more commonalities with regard to the devices being used in that specific segment. If the ranking of accessed URLs is now being used at, e.g., search engines and portals, the ranking as based on device capabilities directly or indirectly inferred, then the segmenting is automatically applied according to the marketing campaigns. This scenario applies in general to all browsers. For example, a distinction can be made between Microsoft Internet Explorer and Firefox at the PC level.

1. A method of providing a service on a data network, wherein:
the data network comprises a plurality of clients and a further plurality of servers;
each specific one of the further plurality of servers has at least a specific one of multiple server network addresses;
the method comprises:
at a network access point on the data network, monitoring requests submitted by the plurality of clients to the multiple server addresses;
creating a database with data representative of the monitored requests;
extracting information from the database indicative of a group behavior of at least one particular group of clients in the plurality of clients with respect to accessing of the multiple server addresses, wherein the extracting comprises:
determining the particular group based on a commonality in a particular sub-set of the requests;
identifying particular ones of the server addresses in the particular sub-set of the requests;
ranking the particular server addresses according to a measure of popularity;
identifying one or more higher ranking ones of the particular server addresses; and
storing the identified one or more higher ranking particular server addresses as associated with the particular client group.

2. The method of claim 1, wherein:
the data representative of the monitored requests comprises at least one of following attributes:
a geographic aspect of client network addresses indicated in the monitored requests submitted by the plurality of clients;
a temporal aspect of the monitored requests;
first data representative of respective configurations of respective ones of the plurality of clients; and
second data representative of respective semantic content of respective responses by the further plurality of servers to the plurality of clients upon the requests; and
the commonality is determined by the sub-set having at least one of the attributes in common.

3. A method of providing on a data network a web portal service targeted to a segment of a population of a plurality of clients wherein:
the plurality of clients use a network access point for submitting requests to a further plurality of servers on the data network;
each respective one of the further plurality of servers has at least one respective one of multiple server network addresses;
the method comprises:
consulting a database storing the server network addresses occurring in the requests, and storing identifications of the plurality of clients, the identifications comprising one or more attributes;
determining particular ones of the plurality of clients belonging to the targeted segment having one or more particular ones of the attributes in common;
further determining at least one particular one of the server network addresses occurring more often than at least one other one of the server network addresses in particular ones of the requests submitted by the particular clients; and
including in the portal a hyperlink to a server site on the data network identified by the particular server network address selected.

4. The method of claim 3, wherein the particular clients are identified as mobile clients.

5. The method of claim 4, wherein the mobile clients are identified as having a particular hardware configuration or a particular software configuration.

6. A method of providing on a data network a search engine service to a population of a plurality of clients wherein:
the plurality of clients use a network access point for submitting requests to a further plurality of servers on the data network;
each respective one of the further plurality of servers has at least one respective one of multiple server network addresses;
the method comprises:
receiving from a specific one of the plurality of clients a specific request for searching the further plurality of servers for a specific information item;
making an inventory of specific ones of the further plurality of server addresses providing the specific information item;
consulting a database storing the server network addresses occurring in the requests, and storing identifications of the population, the identifications comprising one or more attributes;
determining a specific one of the attributes of the specific client;
determining a ranking of the specific server network addresses according to a measure of popularity with a segment of the population of a plurality of clients, the segment being identified in the database by the specific attribute; and
providing to the specific client search results ranked according to the ranking determined.
